(19) United States
(12) Patent Application Publication
(10) Pub. No.: US 2005/0218076 A1
(43) Pub. Date: Oct. 6, 2005

(54) Process for the formation of particulate material

(75) Inventors: Rajesh V. Mehta, Rochester, NY (US); Ramesh Jagannathan, Rochester, NY (US); Seshadri Jagannathan, Pittsford, NY (US); Robert A. Zabelny, Spencerport, NY (US); Ross A. Sprout, Rochester, NY (US); Carl R. Burns, Honeoye, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/814,354

(22) Filed: Mar. 31, 2004

(51) Int. Cl. B01D 11/02

(52) U.S. Cl. 210/639; 264/9; 264/12; 239/9; 424/489

(57) ABSTRACT

A process for the formation of particulate material of a desired substance including: (i) charging a particle formation vessel with a supercritical fluid; (ii) agitating the contents of the particle formation vessel with a rotary agitator, creating a relatively highly agitated zone and a bulk mixing zone; (iii) introducing into the agitated particle formation vessel at least a first feed stream comprising at least a solvent and the desired substance dissolved therein and a second feed stream comprising the supercritical fluid through a second feed stream introduction port, wherein the desired substance is less soluble in the supercritical fluid relative to its solubility in the solvent, and wherein the first and second feed streams are introduced into the highly agitated zone of the particle formation vessel and the first feed stream is dispersed in the supercritical fluid by action of the rotary agitator, allowing extraction of the solvent into the supercritical fluid, and (iv) precipitating particles of the desired substance in the particle formation vessel with a volume-weighted average diameter of less than 100 nanometers.

### FIELD OF THE INVENTION

This invention relates generally to the controlled formation of nanometer-sized particles and/or molecular clusters of substances of interest by a Supercritical Anti-Solvent (SAS) type process.

### BACKGROUND OF THE INVENTION

Supercritical fluids have unique properties, since they combine liquid-like solvent power with gas-like transport properties. They have a large compressibility compared to ideal gases. Therefore, a small change in temperature or pressure near the critical values will result in large changes in the fluid's density and hence its solvent power. These characteristics can be utilized to provide highly controllable solvent properties. Carbon dioxide is the most widely used supercritical fluid, due to the favorable critical parameters (Tc=31.1° C., Pc=73.8 bar), cost and non-toxicity.

Two basic principles for precipitating particles with supercritical fluids have been developed, Rapid Expansion of Supercritical Solutions (RESS) and Supercritical Anti-solvent (SAS) or Gas Anti-solvent (GAS) precipitation. In RESS type processes the sensitivity of solvent power of a supercritical fluid to small changes in pressure is used to trigger a mechanical precipitation of solute particles from the supercritical fluid. However, RESS is not suitable for use with many substances, in view of the requirement for solubility in the supercritical fluid. The SAS or GAS processes, on the other hand, can be used to precipitate particles of a substance that is insoluble in the supercritical fluid, provided that the supercritical fluid is miscible with the liquid in which the substance is dissolved. While RESS type processes are known to produce very small (e.g., less than 100 nanometer) molecular clusters, ion pairs, or dispersed individual molecules under certain conditions, SAS processes have not been known to produce such molecular clusters so far.

Most commonly practiced SAS type processes use a solution or suspension of the substance in a suitable carrier fluid, usually an organic solvent, and contact it with supercritical fluid, usually carbon dioxide, under controlled conditions of pressure, temperature, and rates of addition through capillary nozzles. Their use is extensively documented; see for instance “Strategies for Particle Design using Supercritical Fluid Technologies”, Pharmaceutical Science & Technology Today, 2 (11), 430-440 (1999); “Supercritical Antisolvent Precipitation of Micro- and Nano- Particles”, J. of Supercritical Fluids, 15, 1-21 (1999); and “Particle Design Using Supercritical Fluids: Literature and Patent Survey”, J. of Supercritical Fluids, 20 179-219 (2001).

WO-95/01221 discloses an apparatus for use in the formation of a particulate product in a controlled manner utilizing a SAS type particle formation system. The apparatus comprises a particle formation vessel with means for controlling the temperature in the vessel, together with a means for the co-introduction, into the vessel, of a supercritical fluid and a vehicle containing at least one substance in solution or suspension, such that dispersion and extraction of the vehicle occur substantially simultaneously by the action of the supercritical fluid. The term ‘dispersion’ means the formation of droplets of vehicle. The means for the co-introduction of the supercritical fluid and the vehicle into the particle formation vessel preferably comprises a 2-passage nozzle the outlet end of which communicates with the interior of the vessel, the nozzle having coaxial passages which terminate adjacent to one another at the outlet end, at least one of the passages serving to carry a flow of the supercritical fluid, and at least one of the passages serving to carry a flow of the vehicle in which substance is dissolved or suspended. Such nozzles achieve solution breakup into droplets by shear forces at the jet boundary of the co-introduced fluid streams. Jet dispersion and vehicle extraction efficiencies are thus limited by the magnitude of the shear forces, which if not high enough may give rise to larger than desired particle sizes and broad size and morphological distribution of particles. In the disclosed examples, produced particle size was typically >1 micrometer. This process is also potentially prone to operational problems in terms of the nozzle's propensity to get blocked.

WO-96/006 10 discloses a 3-passage coaxial nozzle for the SAS particle formation process that allows co-introduction of two vehicles that are substantially miscible with each other but only one of them is substantially soluble in the supercritical fluid. The advantage of this process is that it allows the preparation of particles by SAS technique, of substances that could not otherwise be used because of their very low solubility in, or incompatibility with, the necessary solvents. This process, however, does not improve the size, morphology, and operation related limitations identified with WO-95/01221. In the disclosed examples, the nozzles typically enabled production of particles >1 micrometer in size.

Unlike prior art where co-current flow of fluid streams though coaxial passages is taught, U.S. Pat. No. 6,440,337 discloses a SAS process for particle formation wherein an impinging jet arrangement is used for two fluid streams to disperse the solution or suspension and to extract the vehicle from it on the introduction of fluids into the particle formation chamber. The improved dispersion is attributed to the enhanced contact between the solution and supercritical fluids promoted by a higher level of kinetic energy dissipation enabled by the impingement. A further advantage claimed is that particles formed from the solution can be forced away rapidly from the point of formation, which may lead to reduced nozzle blockage. However, the kinetic energy dissipation is still limited by the nozzle geometry and flow rates, and contact time among the impinging streams may be inadequate for complete mixing. Partially mixed streams may then become fully mixed only in the downstream region, where kinetic energy for mass transfer may be significantly lower. This would then still give rise to a broad size distribution and larger mean particle size. The mean size of typical particles was about 0.5 micrometer.

WO-97/31691 teaches an improvement over prior art 2-passage SAS nozzles. A primary nozzle passageway is surrounded by a secondary converging/diverging passageway for an energizing gas such that it would enable deliberate generation of high energy sonic waves downstream of nozzle outlet to effect dispersion and extraction, in addition to and substantially independent of forces typical of prior art nozzles. While improving kinetic energy dissipation rates in the particle formation region, the process is intrinsically less controlled because the frequency of the sonic waves is not constant and difficult to specify a priori. In the disclosed examples, typical particles were >0.5 micrometer in size.

US-2002/0000681 teaches a further SAS type technique, wherein the jet to be dispersed is deflected by a vibrating surface that atomizes the jet into much finer droplets. According to the disclosure, no specialized nozzles are necessary in this process. Also, the frequency of vibration can be precisely controlled. The vibrating surface also generates a fluctuating flow field within the supercritical phase that enhances mass transfer through increased mixing. The disclosure, however, demonstrates that beyond a certain limit (FIGS. 7 & 13), an increase in ultrasound power does not reduce the particle size very much. In the disclosed examples, particles were typically >0.1 micrometer in size. The process also appears to lead to relatively broad distribution of particle size and morphology.

WO 02/058674 discloses a SAS process where when a first liquid (consisting of water, substance of interest, and a modulator) is contacted with a second liquid (consisting of a supercritical anti-solvent and an organic solvent), the presence of modulator provides sub-micron particles of a uniform size (>0.1 micrometer).

W. J. Schmitt, et al., “Finely-divided powders by carrier solution injection into a near or supercritical fluid”, AIChEJ, 41(11), 2476-2485 (1995) discloses an alternative SAS type process where introduction of fluid streams into the particle formation chamber does not require special nozzles. FIG. 1 of the disclosure reveals apparatus including a conventional agitator remotely located from the introduction region as the primary mixing device. The description indicates that the agitator diameter is 5.08 cm, and is located 9 cm below the top of the chamber, while the fluid introduction point is about 6 mm into the chamber. Thus, the agitator is located greater than 1 impeller diameter away from the fluid introduction point. As a result of such remote location, the disclosed apparatus does not provide a high kinetic energy dissipation zone in the fluid stream introduction region. The resultant particles are reported as between 1-10 micrometer in size, some as large as 20-30 micrometer. Schmitt U.S. 5,707,634 similarly also depicts a sketch plan drawing including a mixing chamber autoclave 1 and stirring element 2, but does not provide any details thereof.

Despite its promise in these disclosures, SAS type technology is employed at industrial scale only in a limited number of cases. Also, in general, the disclosures thus far reveal an inability of the known SAS type processes to produce particles smaller than 0.1 micrometer (100 nanometers) in their mean size. This is believed to be attributed to inadequate understanding of controlling factors (see, e.g., “Current issues relating to anti-solvent micronisation techniques and their extension to industrial scales”, J of Supercritical Fluids, 21, 159-177 (2001)). While the prior art teaches that mixing is a factor, it only partially addresses the issues related to “fast kinetics” processes such as particle formation.

Mixing occurs at different length and time scales. Mixing at the length scale of jet diameter is called mesomixing, mixing at the length scale of smallest turbulent eddy in the prevailing flow field is called micromixing, and mixing at the length scale of the particle formation vessel diameter is called macromixing (see, for example, “Turbulent Mixing and Chemical Reactions”, J. Baldyga and J. R. Bourn, ISBN 0-471-98171-0 John Wiley & Sons, (1999)). The prior SAS type process disclosures either address meso- and micro-mixing (e.g., WO-95/01221, WO-96/00610, U.S. 6,440,337, WO-97/31691, U.S. 2002/0000681) or macromixing (e.g., U.S. 5,707,634), but none addresses all of them together. The usefulness of the former is usually limited to systems that are small in size. They do not perform as efficiently when systems are scaled up in size. This is because they have a limited dynamic range in terms of micro- and meso-mixing efficiency as a function of volumetric flow rates of jet solutions, and also because macro-mixing imperfections would create increasingly larger non-uniformity of concentrations in the particle formation vessel. Such non-uniformity contributes to broad size and morphological distributions on the one hand and larger particle sizes on the other. The usefulness of the latter is severely limited because the resultant particle size is much larger than that from the other processes and the lack of efficient micro- and meso-mixing makes the process inherently less controlled. The present invention addresses process engineering issues related to “fast kinetics” mediated SAS type processes at the industrial scale, especially with respect to precipitation of particles <100 nm in size.

### SUMMARY OF THE INVENTION

In accordance with one embodiment of the invention, a process for the formation of particulate material of a desired substance is disclosed, the process comprising:
(i) charging a particle formation vessel, the temperature and pressure in which are controlled, with a supercritical fluid;
(ii) agitating the contents of the particle formation vessel with a rotary agitator comprising an impeller having an impeller surface and an impeller diameter, creating a relatively highly agitated zone located within a distance of one impeller diameter from the surface of the impeller of the rotary agitator, and a bulk mixing zone located at distances greater than one impeller diameter from the surface of the impeller;
(iii) introducing into the agitated particle formation vessel at least a first feed stream comprising at least a solvent and the desired substance dissolved therein through a first feed stream introduction port and a second feed stream comprising the supercritical fluid through a second feed stream introduction port, wherein the desired substance is less soluble in the supercritical fluid relative to its solubility in the solvent and the solvent is soluble in the supercritical fluid, and wherein the first and second feed stream introduction ports are located within a distance of one impeller diameter from the surface of the impeller of the rotary agitator such that the first and second feed streams are introduced into the highly agitated zone of the particle formation vessel and the first feed stream is dispersed in the supercritical fluid by action of the rotary agitator, allowing extraction of the solvent into the supercritical fluid, and
(iv) precipitating particles of the desired substance in the particle formation vessel with a volume-weighted average diameter of less than 100 nanometers.

### BRIEF DESCRIPTION OF THE DRAWINGS

In the detailed description of the preferred embodiments of the invention presented below, reference is made to the accompanying figures, in which:

FIG. 1: Optical miscroscopy image of particles obtained in Example 1.

FIG. 2: Optical miscroscopy image of particles obtained in Example 2.

FIG. 3: Optical miscroscopy image of particles obtained in Example 3.

FIG. 4: Graph of particle size distribution of particles obtained in Example 4.

FIG. 5: Transmission electron micrograph of particles obtained in Example 5.

FIG. 6: Transmission electron micrograph of particles obtained in Example 6.

FIG. 7A: Transmission electron micrograph of particles obtained in Example 7.

FIG. 7B: Graph of particle size frequency of particles obtained in Example 7.

FIG. 8: Transmission electron micrograph of particles obtained in Example 8.

### DETAILED DESCRIPTION OF THE INVENTION

In accordance with this invention, it has been found that nanometer sized particles of a desired substance can be prepared by precipitation of the desired substance from a solution upon contact with a supercritical fluid antisolvent under conditions as described herein. In practicing this invention, feed materials, i.e., the supercritical fluid antisolvent and the solvent/solute solution, are intimately mixed in a particle formation vessel in a zone of highly agitated turbulent flow to precipitate particles of the solute. The particles are then expelled from the highly agitated zone by action of bulk mixing in the particle formation vessel. In practicing the invention, it is generally desirable to introduce the feed streams into the highly agitated mixing zone in opposing directions although they can be introduced in the same direction, if desired. A significant feature of this invention is that precipitated particles of sizes less than 100 nanometers can be produced free of high levels of non-uniform large particles.

The process of the invention is applicable to the preparation of precipitated particles of a wide variety of materials for use in, e.g., pharmaceutical, agricultural, food, chemical, imaging (including photographic and printing, and in particular inkjet printing), cosmetics, electronics (including electronic display device applications, and in particular color filter arrays and organic light emitting diode display devices), data recording, catalysts, polymer (including polymer filler applications), pesticides, explosives, microstructure/nanostructure architecture building, and coating applications, all of which can benefit from use of small particulate material. Materials of a desired substance precipitated in accordance with the invention may be of the types such as organic, inorganic, metallo-organic, polymeric, oligomeric, metallic, alloy, ceramic, a synthetic and/or natural polymer, and a composite material of these previously mentioned. Precipitated materials can be, for example, colorants (including dyes and pigments), agricultural chemicals, pharmaceutically useful compounds, commercial chemicals, fine chemicals, food items, nutrients, pesticides, photographic chemicals, explosive, cosmetics, protective agents, metal coating precursor, or other industrial substances whose desired form is that of a deposited film, fine particle dispersion, or powder. Dyes and pigments are particularly preferred functional materials for use in printing applications.

The desired material to be precipitated is first dissolved in a suitable liquid carrier solvent. As in known SAS type processes, solvents for use in the present invention may be selected based on ability to dissolve the desired material, miscibility with a supercritical fluid antisolvent, toxicity, cost, and other factors. The solvent/solute solution is then contacted with a supercritical fluid antisolvent in a particle formation vessel, the temperature and pressure in which are controlled, where the supercritical fluid is selected based on its solubility with the solvent and relative insolubility with the desired particulate material (compared to its solubility in the solvent), so as to initiate precipitation of the solute from the solvent upon rapid extraction of the solvent into the supercritical fluid. Any supercritical fluid known for use as an antisolvent in SAS type processes may be employed, with supercritical CO₂ being generally preferred.

In accordance with the invention, the solvent/solute solution and supercritical fluid antisolvent are contacted in a particle formation vessel by introducing feed streams of such components into a highly agitated zone of the particle formation vessel, such that the first solvent/solute feed stream is dispersed in the supercritical fluid by action of a rotary agitator. Effective micro and meso mixing, and resulting intimate contact of the feed stream components, enabled by the introduction of the feed streams into the vessel within a distance of one impeller diameter from the surface of the impeller of the rotary agitator, has been surprisingly found to enable precipitation of particles of the desired substance in the particle formation vessel with a volume-weighted average diameter of less than 100 nanometers, preferably less than 50 nanometers, and most preferably less than 10 nanometers. In addition, a narrow size-frequency distribution for the particles may be obtained. The measure of the volume-weighted size-frequency distribution, or coefficient of variation (mean diameter of the distribution divided by the standard deviation of the distribution), e.g., is typically 50% or less, with coefficients of variation of even less than 20% being enabled. The size-frequency distribution may therefore be monodisperse. Process conditions may be controlled in the particle formation vessel, and changed when desired, to vary particle size as desired.

Preferred mixing apparatus which may be used in the process of the invention includes rotary agitators of the type which have been previously disclosed for use in the photographic silver halide emulsion art for precipitating silver halide particles by reaction of simultaneously introduced silver and halide salt solution feed streams. Such rotary agitators may include, e.g., turbines, marine propellers, discs, and other mixing impellers known in the art (see, e.g., U.S. Pat. Nos. 3,415,650; 6,513,965, 6,422,736; 5,690,428, 5,334,359, 4,289,733; 5,096,690; 4,666,669, EP 1156875, WO-016051 1).

While the specific configurations of the rotary agitators which may be employed in the present invention may vary significantly, they will each employ at least one impeller having a surface and a diameter, which impeller is effective in creating a highly agitated zone in the vicinity of the agitator. The term “highly agitated zone” describes a zone in the close proximity of the rotary agitator within which a significant fraction of the power provided for mixing is dissipated by the material flow. Typically it is contained within a distance of one impeller diameter from the rotary impeller surface. Introduction of the supercritical fluid antisolvent feed stream and solvent/solute feed stream into a particle formation vessel in close proximity to a rotary mixer, such that the feed streams are introduced into a relatively highly agitated zone created by the action of the rotary agitator in accordance with the invention provides for accomplishing meso-, micro-, and macro-mixing of the feed stream components to practically useful degrees. Depending on the processing fluid properties and the dynamic time scales of transfer or transformation processes associated with the particular supercritical fluid, solvent and solute materials employed, the specific rotary agitator employed may be selected to optimize meso-, micro-, and macro-mixing to varying practically useful degrees.

Mixing apparatus which may be employed in one particular embodiment of the invention includes mixing devices of the type disclosed in Research Disclosure, Vol. 382, February 1996, Item 38213. In such apparatus, means are provided for introducing feed streams from a remote source by conduits which terminate close to an adjacent inlet zone of the mixing device (less than one impeller diameter from the surface of the mixer impeller). To facilitate mixing of the feed streams, they are introduced in opposing direction in the vicinity of the inlet zone of the mixing device. The mixing device is vertically disposed in a reaction vessel, and attached to the end of a shaft driven at high speed by a suitable means, such as a motor. The lower end of the rotating mixing device is spaced up from the bottom of the reaction vessel, but beneath the surface of the fluid contained within the vessel. Baffles, sufficient in number of inhibit horizontal rotation of the contents of the vessel, may be located around the mixing device. Such mixing devices are also schematically depicted in U.S. Pat. Nos. 5,549,879 and 6,048,683, the disclosures of which are incorporated by reference.

Mixing apparatus which may be employed in another embodiment of the invention includes mixers which facilitate separate control of feed stream dispersion (micromixing and mesomixing) and bulk circulation in the precipitation reactor (macromixing), such as descried in U.S. Pat. No. 6,422,736, the disclosure of which is incorporated by reference. Such apparatus comprises a vertically oriented draft tube, a bottom impeller positioned in the draft tube, and a top impeller positioned in the draft tube above the first impeller and spaced therefrom a distance sufficient for independent operation. The bottom impeller is preferably a flat blade turbine (FBT) and is used to efficiently disperse the feed streams, which are added at the bottom of the draft tube. The top impeller is preferably a pitched blade turbine (PBT) and is used to circulate the bulk fluid through the draft tube in an upward direction providing a narrow circulation time distribution through the reaction zone. Appropriate baffling may be used. The two impellers are placed at a distance such that independent operation is obtained. This independent operation and the simplicity of its geometry are features that make this mixer well suited in the scale-up of precipitation processes. Such apparatus provides intense micromixing, that is, it provides very high power dissipation in the region of feed stream introduction.

Rapid dispersal of the feed streams is important in controlling several key factors in the present invention, such as supersaturation caused by mixing of the solvent/solute with the supercritical fluid antisolvent. The more intense the turbulent mixing is in the feed zone, the more rapidly the feed will be dissipated and mixed with the bulk. This is preferably accomplished using a flat bladed impeller and introducing the feed streams directly into the high energy dissipatation zone of the impeller. The flat bladed impeller possesses high shear and dissipation characteristics using the simplest design possible. The apparatus as described in U.S. Pat. No. 6,422,736 also provides superior bulk circulation, or macromixing. Rapid homogenization rates and narrow circulation time distributions are desirable in achieving process uniformity. This is accomplished by employing an axial upward directed flow field, which is further enhanced by the use of a draft tube. This type of flow provides a single continuous circulation loop with no dead zones. In addition to directing fluid motion in an axial direction, the draft tube provides the means to run the impeller at much higher rpm, and confines the precipitation zone to the intensely mixed interior of the tube. To further stabilize the flow field, a disrupter device may be attached to the discharge of the draft tube, to reduce the rotational component of flow.

The use of a mixing device of the type described in U.S. Pat. No. 6,422,736 also provides a means for easily changing the power dissipation independently from the bulk circulation. This allows flexibility in choosing the mixing conditions that are optimal for the particular materials being used. This separation of bulk and hot zone mixing is accomplished by locating the pitched bladed impeller near the exit of the draft tube. The pitch bladed impeller provides a high flow to power ratio, which is easily varied, and is a simple design. It controls the rate of circulation through the draft tube, the rate being a function of the pitch angle of the blades, number and size of blades, etc. Because the pitch bladed impeller dissipates much less power than the flat bladed impeller, and is located sufficiently away from the feed point, the pitch bladed impeller does not interfere with the intensity of hot zone mixing in the draft tube, just the circulation rate through it. By placing the impellers a certain distance apart, this effect of independent mixing is maximized. The distance between the impellers also strongly affects the degree of back mixing in the hot zone, and hence provides yet another mixing parameter that can be varied. To further enable independent control of mixing parameters, the upper and lower impellers can have different diameters or operate at different speeds rather than the same speed. Also, the feed streams can be introduced by a multitude of tubes at various locations in the draft tube and with various orifice designs.

In the context of SAS type processes, the present invention thus addresses relevant mixing processes adequately for the first time, which surprisingly leads to dramatically smaller particle sizes. In fact, it may be more appropriate to call these particles molecular clusters where they are made up of only a small number of molecules. While Rapid Expansion of Supercritical Solvent (RESS) processes have been known to produce very small molecular clusters, ion pairs, or dispersed individual molecules under certain conditions, SAS processes have not been previously known to produce such molecular clusters. Thus the present invention offers, for the first time, the ability of matching the capability of a SAS type process to a RESS process in terms of particle size, morphology, and the resultant properties. The present invention thus opens up a much larger class of materials for processing via use of conventional organic solvents, as the RESS process is generally limited to materials that are soluble in supercritical fluids. Because of superior management of mixing interactions, the present invention also leads to additional advantages in terms of narrower particle size and morphological distribution. The same control of mixing process also makes the inventive process more robust and scalable.

It is well recognized that progress to a fully continuous particle formation process is limited for SAS type techniques as the powder of the desired substance is typically collected in the particle formation vessel under pressure, and for RESS type techniques by depletion of the stock solution to be expanded. In a preferred embodiment of the invention, the process may be performed in an essentially continuous manner by exhausting supercritical fluid, solvent and the desired substance from the particle formation vessel at a rate substantially equal to the rate of addition of such components to the vessel in step, while maintaining temperature and pressure in the vessel at a desired constant level, such that formation of particulate material occurs under essentially steady-state continuous conditions. Such continuous operation is believed to be facilitated by the very fine nature of the precipitated particles, which allows the supercritical fluid, solvent and desired substance to be simply exhausted from the particle formation vessel by passage to an expansion chamber. In such embodiment, passage to the expansion chamber may be through, e.g., a backpressure regulator, a capillary, or a flow distributor. Once passed to the expansion chamber, the particles of the desired substance may be collected without interruption of the precipitation in the agitated particle formation vessel. If desired, supercritical fluid, solvent and desired substance may be exhausted from the particle formation vessel directly into a solution to form a dispersion of the formed particles of the desired substance.

Very fine particles obtained in accordance with the invention may further be printed, coated, or otherwise deposited on a substrate upon expansion of the supercritical fluid mixture in processes similarly as described in concurrently filed, copending, commonly assigned U.S. Ser. Nos. ______ (Kodak Docket No. which are incorporated by reference herein. Since the process of the present invention produces fine powder that is comparable to those produced by RESS techniques, RESS -based thin film deposition techniques (including method and apparatus, with minor changes to account for low level of organic solvent present in the supercritical mixture) may also be employed for the particles produced by the present invention. For example, after formation of particles in a particle formation vessel by SAS type process in accordance with the invention, the resulting mixture of very fine (less than 100 nanometers, preferably less than 50 nanometers, most preferably less than 10 nanometers) precipitated particles and compressed supercritical fluid may be expanded under controlled conditions and thin films of the particles may be coated on a substrate, similarly as in the RESS (and other similar) type coating processes described in U.S. Pat. Nos. 4,582,731, 4,734,227, 4,734,451, 4,970,093, 4,737,384, 5,106,650, and Fulton et al., Polymer, Vol. 44, 3627-3632 (2003), the disclosures of which are incorporated by reference herein. Condensation of solvent from the supercritical fluid, solvent, and precipitated solute mixture upon expansion of the mixture may be avoided or minimized, if desired, by selection of a solvent with sufficiently high vapor pressure, and/or control of the temperature and pressure of the expansion chamber.

Very fine particles obtained in accordance with the invention may also be printed, coated, or otherwise deposited upon expansion of the supercritical fluid mixture, similarly as described in the deposition or printing processes of WO 02/45868 A2, US 6471327, US 6692906, US 20020118246 A1, US 20020118245 A1, and US20030107614, the disclosures of which are incorporated by reference herein. Very fine particles obtained in accordance with the invention may further also be printed, coated, or otherwise deposited upon expansion of the supercritical fluid mixture in process similarly as described in copending, commonly assigned U.S. Ser. Nos. 10/313,549, 10/313,587, and 10/460,814 (systems for producing patterned deposition from compressed fluids); Ser. No. 10/314,379 (system for producing patterned deposition from compressed fluid in a dual controlled deposition chamber); Ser. No. 10/313,427 (system for producing patterned deposition from compressed fluid in a partially opened deposition chamber); Ser. No. 10/313,591 (supercritical CO₂ based marking system to make organic small molecule and polymeric light emitting diode devices); Ser. Nos. 10/224,783 and 10/300,099 (solid-state lighting using dense gas coatings); Ser. Nos. 10/602,429 and 10/602,134 (method of color tuning light emitting displays); Ser. No. 10/602,430 (color gamut improvement by process variations in supercritical fluid printing); Ser. No. 10/602,840 (method and apparatus for altering printed colors with process changes); and Ser. No. 10/625,426 (security method using supercritical fluid printing), the disclosures of which are incorporated by reference herein.

### EXAMPLES

### Example 1

(Control)

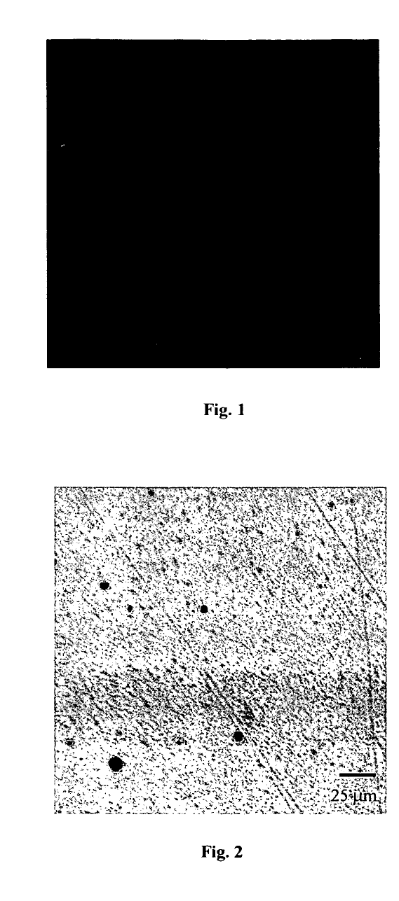

A nominally 1800 ml stainless steel particle formation vessel was fitted with a 4 cm diameter agitator of the type disclosed in U.S. Pat. No. 6,422,736, comprising a draft tube and bottom and top impellers . The feed port for solution (of Dye-1 in acetone) was located outside the draft tube, vertically above the plane of the bottom impeller such that the feed port was at least 5 cm away from the tip of the bottom impeller (i.e., outside a relatively highly agitated zone created within a distance of one impeller diameter from the impeller surface). It was also directed tangentially to the diameter of the draft tube. The feed port for CO₂ was located very close (i.e., within one impeller diameter) to the mixing impeller as disclosed for the inlet tubes for the mixer in U.S. Pat. No. 6,422,736. The outlet port of the particle formation vessel had a stainless steel filter whose nominal filtration efficiency for 0.5 micrometer particles was 90%. A stainless steel sampling cell with high surface polish was also mounted inside the particle formation vessel to capture the particles formed by the process. The outlet port of the particle formation vessel was connected via a 25.4 cm long stainless steel capillary, 0.0254 cm in diameter, to an expansion chamber where ambient conditions of temperature and pressure prevailed. CO₂ was added to the particle formation vessel while adjusting temperature to 90 C and pressure to 280 bar and while stirring at 2775 revolutions per minute. The addition of CO₂ at 60 g/min through a feed port that had a 200 micrometer orifice at its tip, and a 0.1 wt% solution of Dye-1 in acetone at 2 g/min, through a 100 micrometer tip, was then commenced. The molecular structure of Dye-1 was as follows: 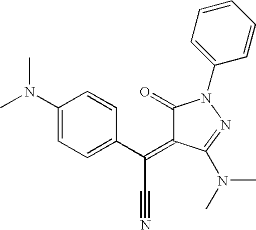
The pressure of the particle formation chamber began to rise and reached 315 bar in 29 minutes. At this point, the filter was considered plugged and the feed addition was stopped. The vessel was then depressurized carefully to atmospheric conditions in 20 min and was opened for examination. The sampling cell was removed and particles deposited on the sampling cell were then examined by optical microscopy as shown in FIG. 1. The preponderance of >1 micrometer particles (single or agglomerates) is evident.

### Example 2

(Invention)

The procedure for Example I was repeated, with the exception that the solution feed port was located close to the bottom impeller (similar to the CO₂ feed port) as disclosed for the inlet tubes for the mixer in U.S. Pat. No. 6,422,736, such that both the solution and the CO₂ feed streams were introduced into a highly agitated zone within one impeller diameter of the bottom impeller. The pressure of the particle formation chamber increased from 280 bar at the start of the solution addition to 315 bar at the end of the solution addition in 54 minutes. After the depressurization, the particles deposited on the sampling cell surface were examined by optical microscopy as shown in FIG. 2. Despite almost 2× longer run time compared to Example 1, the sampling cell surface revealed significantly fewer >1 micrometer single or agglomerated particles, with a preponderance of finer particles.

### Example 3

(Invention)

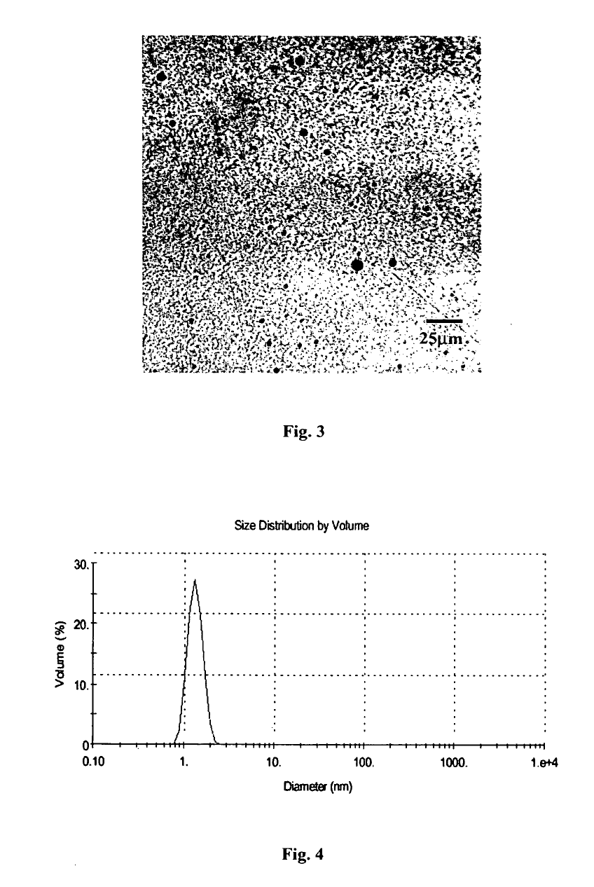

The procedure for Example 2 was repeated with the exception that the stirring speed was maintained at 2078 revolutions per minute. The pressure of the particle formation chamber increased from 280 bar at the start of the solution addition to 320 bar at the end of the solution addition in 60 minutes. After the depressurization, the particles deposited on the sampling cell surface were examined by optical microscopy as shown in FIG. 3. Despite almost 2× increase in run time, and about 25% reduction in the stirring speed, compared to Experiment 1, the sampling cell surface showed significantly less deposits of >1 micrometer particles, with a preponderance of finer particles.

### Example 4

(Invention)

The particle formation vessel and feed port configuration employed in Example 2 were used and CO₂ was added while adjusting temperature to 90 C and pressure to 300 bar. The stirring speed was maintained at 2775 revolutions per minute. The addition of CO₂ at 60 g/min through a feed port that had a 200 micrometer orifice at its tip, and a 0.5 wt % solution of Dye-1 (same dye as in Examples 1-3, but at a 5× concentration) in acetone at 2 g/min, through a 100 micrometer tip, was then commenced. The bottom of the particle formation vessel was connected, via an automatic backpressure regulator, to an expansion chamber where ambient conditions of temperature and pressure prevailed. The temperature and the pressure of the particle formation chamber were controlled at constant level at 90 C and 300 bar respectively. After one hour of continuous operation, the outflow from the particle formation vessel was redirected away from the expansion chamber. Particles deposited on the walls of the expansion chamber were scraped off and dispersed in water. The particle size distribution was then measured with Malvern High Performance Particle Sizer (Malvern Instruments Ltd., U.K.). As shown in FIG. 4, the volume-weighted mean particle size was 1.37 nm, and the standard deviation of the size distribution was 0.237 nm (i.e., coefficient of variation of 17%).

### Example-5

(Invention)

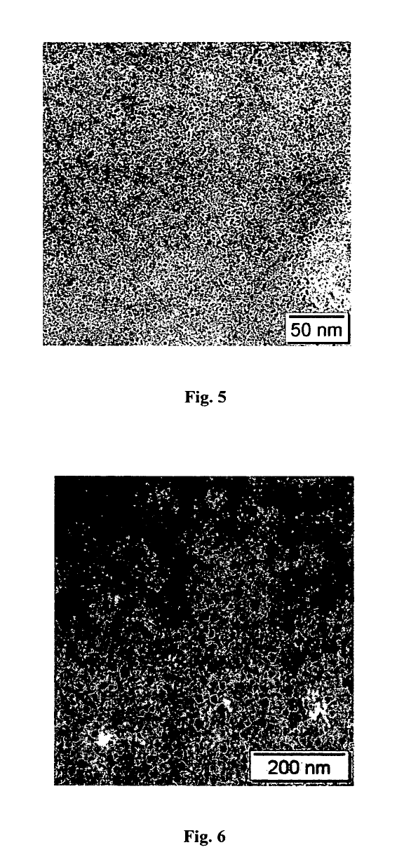

The particle formation vessel and feed port configuration employed in Example 2 were used and CO₂ was added while adjusting temperature to 63 C and pressure to 180 bar. The stirring speed was maintained at 2775 revolutions per minute. The addition of CO₂ at 40 g/min through a feed port that had a 200 micrometer orifice at its tip, and a 0.75 wt % solution of Dye-1 (same dye as in Examples 1-3, but at 7.5× concentration) in acetone at 1 g/min, through a 100 micrometer tip, was then commenced. The bottom of the particle formation vessel was connected, via an automatic backpressure regulator, to an expansion chamber where pressure was ambient and temperature was 55 C. The temperature and the pressure of the particle formation chamber were controlled at constant level at 63 C and 180 bar respectively. After 25 minutes of continuous operation, the acetone solution addition was stopped. After additional 15 minutes CO₂ addition was also stopped. Particles deposited on the walls of the expansion chamber were scraped off and dispersed in water. The particle size distribution was then examined under Transmission Electron Microscope. As shown in FIG. 5, the mean particle size was <5nm.

### Example 6

(Invention)

To a nominally 1800 ml stainless steel particle formation vessel, fitted with a 4 cm diameter agitator of the type disclosed in RD 38213, was added 1147 g of CO₂ while adjusting temperature to 45 C and pressure to 150 bar while stirring at 2775 revolutions per minute. The addition of CO₂ at 80 g/min and a solution of Dye-2 [Disperse Red-60 (C₂₀H₁₃NO₄)]

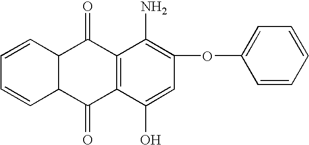

### Disperse Red 60

### (1 -amino-4-hydroxy-2-phenoxy-9, 10-anthraquinone)

in acetone, having a concentration of 2 g dye/ 100 g Acetone, at 1 g/min was then commenced. The CO₂ and solution feed streams were introduced though feed ports which terminate close to an adjacent inlet zone of the mixing device (less than one impeller diameter from the surface of the mixer impeller), as disclosed in RD 38213. The bottom of the particle formation vessel was connected, via an automatic backpressure regulator, to an expansion chamber where ambient conditions of temperature and pressure prevailed. The temperature and the pressure of the particle formation chamber were controlled at constant level at 45 C and 150 bar respectively. After 30 min of continuous operation, the dye solution addition was stopped and CO₂ flow was adjusted to 60 g/min. After 25 min, CO₂ flow was stopped and particle formation chamber depressurized gradually to ambient pressure over 21 min. Particles deposited on the walls of the expansion chamber were then scraped off, dispersed in water, and observed under a Transmission Electron Microscope. As shown in FIG. 6, the mean particle size was found to be <20 nm.

### Example-7

(Invention)

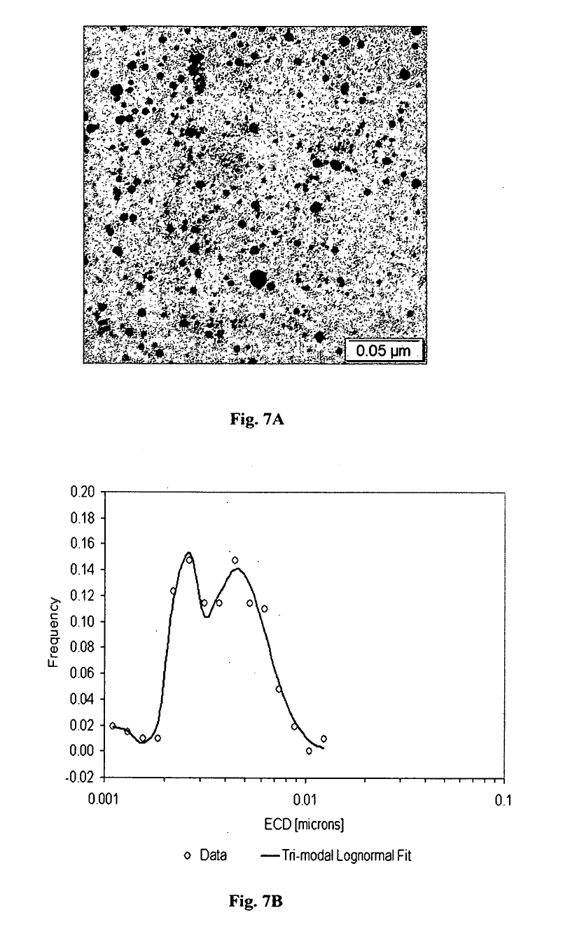

To a nominally 1800 ml stainless steel particle formation vessel, fitted with a 4 cm diameter agitator and having a feed port configuration, both disclosed in U.S. 6,422,736, was added 1096 g of CO₂ while adjusting temperature to 70 C and pressure to 300 bar while stirring at 2775 revolutions per minute. The addition of CO₂ at 30 g/min through a feed port that had a 200 micrometer orifice at its tip, and a solution of salicylic acid in acetone, having a concentration of 2 g salicylic acid/100 g Acetone, at 5 g/min, through a 100 micrometer tip, was then commenced. The bottom of the particle formation vessel was connected, via an automatic backpressure regulator, to an expansion chamber where ambient conditions of temperature and pressure prevailed. The temperature and the pressure of the particle formation chamber were controlled at constant level at 70 C and 300 bar respectively. After one hour of continuous operation, the outflow from the particle formation vessel was redirected away from the expansion chamber. Particles deposited on the walls of the expansion chamber were then scraped off, dispersed in heptane, and analyzed for size by Transmission Electron Microscopy (FIG. 7A) and Image Analysis (FIG. 7B). The mean particle size is <5 nm.

### Example-8

(Invention)

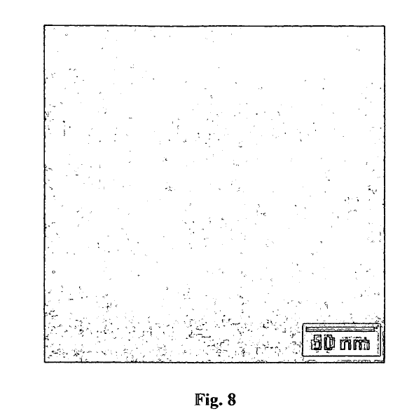

The particle formation vessel and feed port configuration employed in Example 2 were used and CO₂ was added while adjusting temperature to 45 C and pressure to 180 bar. The stirring speed was maintained at 2775 revolutions per minute. The addition of CO₂ at 80 g/min through a feed port that had a 200 micrometer orifice at its tip, and a 0. 5 wt % solution of an organic light emitting diode dopant compound (C545-T, whose structure is shown below) in acetone at 1 g/min, through a 100 micrometer tip, was then commenced. 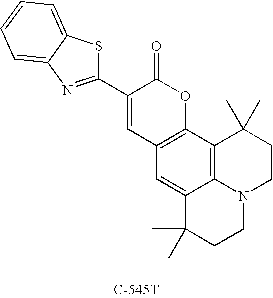
The bottom of the particle formation vessel was connected, via an automatic backpressure regulator, to an expansion chamber where pressure was ambient and temperature was 55 C The temperature and the pressure of the particle formation chamber were controlled at constant level at 45 C and 180 bar respectively. After 25 minutes of continuous operation, the acetone solution addition was stopped and CO₂ flow rate reduced to 60 g/min. After additional 25 minutes of CO₂ addition, it was also stopped. Particles deposited on the walls of the expansion chamber were scraped off and dispersed in heptane. The particle size distribution was then examined under Transmission Electron Microscope. As shown in FIG. 8, the mean particle size was <10 nm.

It is to be understood that elements not specifically shown or described may take various forms well known to those skilled in the art. Additionally, materials identified as suitable for various facets of the invention are not limiting. These are to be treated as exemplary, and are not intended to limit the scope of the invention in any manner.

1. A process for the formation of particulate material of a desired substance comprising:
(i) charging a particle formation vessel, the temperature and pressure in which are controlled, with a supercritical fluid;
(ii) agitating the contents of the particle formation vessel with a rotary agitator comprising an impeller having an impeller surface and an impeller diameter, creating a relatively highly agitated zone located within a distance of one impeller diameter from the surface of the impeller of the rotary agitator, and a bulk mixing zone located at distances greater than one impeller diameter from the surface of the impeller;
(iii) introducing into the agitated particle formation vessel at least a first feed stream comprising at least a solvent and the desired substance dissolved therein through a first feed stream introduction port and a second feed stream comprising the supercritical fluid through a second feed stream introduction port, wherein the desired substance is relatively insoluble in the supercritical fluid relative to its solubility in the solvent and the solvent is soluble in the supercritical fluid, and wherein the first and second feed stream introduction ports are located within a distance of one impeller diameter from the surface of the impeller of the rotary agitator such that the first and second feed streams are introduced into the highly agitated zone of the particle formation vessel and the first feed stream is dispersed in the supercritical fluid by action of the rotary agitator, allowing extraction of the solvent into the supercritical fluid, and
(iv) precipitating particles of the desired substance in the particle formation vessel with a volume-weighted average diameter of less than 100 nanometers.

2. A process according to claim 1, further comprising (v) exhausting supercritical fluid, solvent and the desired substance from the particle formation vessel at a rate substantially equal to the rate of addition of such components to the vessel in step (iii) while maintaining temperature and pressure in the vessel at a desired constant level, such that formation of particulate material occurs under essentially steady-state continuous conditions.

3. A process according to claim 2, wherein the supercritical fluid, solvent and desired substance are exhausted from the particle formation vessel by passage to an expansion chamber.

4. A process according to claim 3, wherein the supercritical fluid, solvent and desired substance are exhausted from the particle formation vessel by passage through a backpressure regulator.

5. A process according to claim 3, wherein the supercritical fluid, solvent and desired substance are exhausted from the particle formation vessel by passage through a capillary.

6. A process according to claim 3, wherein the supercritical fluid, solvent and desired substance are exhausted from the particle formation vessel by passage through a flow distributor.

7. A process according to claim 3, further comprising collecting particles of the desired substance in the expansion chamber.

8. A process according to claim 1, wherein the supercritical fluid, solvent and desired substance are exhausted from the particle formation vessel directly into a solution to form a dispersion of the formed particles of the desired substance.

9. A process according to claim 1, wherein particles of the desired substance are precipitating in the particle formation vessel with a volume-weighted average diameter of less than 50 nanometers.

10. A process according to claim 1, wherein particles of the desired substance are precipitating in the particle formation vessel with a volume-weighted average diameter of less than 10 nanometers.

11. A process according to claim 10, wherein the coefficient of variation of the particle size distribution of the particles of the desired substance precipitated in the particle formation vessel is less than 50%.

12. A process according to claim 11, wherein the coefficient of variation of the particle size distribution of the particles of the desired substance precipitated in the particle formation vessel is less than 20%.

13. A process according to claim 1, wherein the coefficient of variation of the particle size distribution of the particles of the desired substance precipitated in the particle formation vessel is less than 50%.

14. A process according to claim 13, wherein the coefficient of variation of the particle size distribution of the particles of the desired substance precipitated in the particle formation vessel is less than 20%.

15. A process according to claim 1, wherein the desired substance comprises a colorant.

16. A process according to claim 15, wherein the desired substance comprises a dye.

17. A process according to claim 1, wherein the desired substance comprises a pharmaceutically useful compound.

18. A process according to claim 1, wherein the desired substance comprises a compound used to make organic electroluminescent devices.
